(19) United States
(12) Patent Application Publication
(10) Pub. No.: US 2022/0358118 A1
(43) Pub. Date: Nov. 10, 2022

(54) DATA SYNCHRONIZATION IN EDGE COMPUTING NETWORKS

(71) Applicant: International Business Machines Corporation, Armonk, NY (US)

(72) Inventors: Michal Paluch, Kraków (PL); Marcel Butucea Panait, Brno (CZ); Erik Rueger, Ockenheim (DE); Nicolo' Sgobba, Fasano (IT)

(21) Appl. No.: 17/315,749

(22) Filed: May 10, 2021

(51) Int. Cl. G06F 16/23; G06F 16/27; H04L 29/08

(52) U.S. Cl. CPC G06F 16/2379; G06F 16/27; H04L 67/1095; H04L 67/1051

(57) ABSTRACT

A computer system synchronizes data in an edge computing network. A leader node is elected from a plurality of nodes, wherein the plurality of nodes includes a plurality of follower nodes that each cast a single vote for a candidate node, and wherein the candidate node is elected as the leader node in response to the candidate node receiving votes from a majority of the nodes. The leader node receives a request from a follower node comprising data to be replicated across the nodes, and transmits the data to the other nodes. When a majority of nodes receive the data, the leader node transmits instructions to the nodes to cause each node to commit the data to a data log maintained by each node. Embodiments of the present invention further include a method and program product for synchronizing data in substantially the same manner described above.

### BACKGROUND

### 1. Technical Field

Present invention embodiments relate to edge computing, and more specifically, to synchronizing data among computing nodes of an edge computing network.

### 2. Discussion of the Related Art

Edge computing refers to a field of computer science in which processing is distributed and performed at locations closer to where the processing is needed in order to improve response times and save bandwidth. Edge computing is transforming the way that data is handled, processed, and delivered, and is becoming increasingly popular as the number of network-connected devices, such as Internet of Things devices, grows. Faster communication technologies have enabled edge computing systems to support real-time applications, such as data gathering by sensors, media processing and analytics, self-driving vehicles, robotic devices, and more. However, the networks and/or communication protocols by which edge computing devices communicate may often be less reliable, making it difficult for edge devices to communicate with each other.

### SUMMARY

According to one embodiment of the present invention, a computer system synchronizes data in an edge computing network. A leader node is elected from a plurality of nodes comprising wirelessly-communicating computing devices, wherein the plurality of nodes includes a plurality of follower nodes that each cast a single vote for a candidate node, and wherein the candidate node is elected as the leader node in response to the candidate node receiving votes from a majority of the plurality of nodes. A request is received at the leader node from a follower node comprising data to be replicated across the plurality of nodes. The leader node transmits the data from the leader node to the plurality of nodes. In response to the leader node receiving responses acknowledging receipt of the data from the maj ority of the plurality of nodes, the leader node transmits instructions to the plurality of nodes to cause each node to commit the data to a data log maintained by each node. Embodiments of the present invention further include a method and program product for synchronizing data in an edge computing network in substantially the same manner described above. Thus, present invention embodiments enable synchronization of data across a plurality of nodes in a manner that safeguards against data loss while ensuring consensus among the nodes.

Various other embodiments of the present invention will now be discussed. In some embodiments, the leader node comprises a candidate node prior to being elected as the leader node, the candidate node comprises a former follower node that becomes the candidate node in response to an election timeout elapsing, and the election timeout of each follower node is reset in response to the follower node receiving a heartbeat message from the leader node. Thus, present embodiments provide a mechanism to guarantee that a group of nodes always either has a leader node, or is in the process of electing a leader node, thereby preventing data synchronization from being disrupted. In some embodiments, the candidate node broadcasts a request for votes from the plurality of follower nodes. By broadcasting a request for votes, the candidate node may receive votes from any nodes that are within range, thereby also announcing the candidate node's candidacy as a potential new leader node. In some embodiments, a term number is maintained by each node of the plurality of nodes, and in response to being elected, the leader node increments the term number and transmits instructions to the plurality of follower nodes to cause each follower node to increment the term number maintained by the follower node. Thus, when a failure in communication leads to a network being partitioned, the individual nodes of the network can detect the partition to begin repairing the partition. In some embodiments, in response to a node of the plurality of nodes determining that a new leader node has a higher term number than the node, the node becomes a follower node of the new leader node. By following a node with a higher term count, a follower node can recover from a network partition event. In some embodiments, a subset of nodes of the plurality of nodes no longer receiving data from the leader node causes the subset of nodes to elect, by the subset of nodes, a subset leader node to form a partitioned network comprising the subset of nodes. Thus, during a network partition event, any nodes that are partitioned away from other nodes can form their own sub-network and continue to gather and share data. In some embodiments, in response to the subset of nodes resuming to receive data from the leader node of the plurality of nodes, the subset of nodes become follower nodes of the leader node, and additional data is transmitted from the leader node to the plurality of nodes to cause data logs of each node of the subset of nodes to resynchronize with the data log of the leader node. Thus, when a group of nodes recovers from a network partition event, the data collected or generated by nodes that were unable to communicate during the partition can be synchronized across all nodes. In some embodiments, the leader node receives uncommitted data obtained or produced by the subset of nodes, and wherein the leader node transmits the uncommitted data to the plurality of nodes to cause each node of the plurality of nodes to commit the uncommitted data to the data log maintained by each node of the plurality of nodes. Thus, when a group of nodes that was unable to commit data recovers from a network partition event, the data collected or generated by nodes that were unable to communicate and commit the data during the partition can be committed and synchronized across all nodes.

### BRIEF DESCRIPTION OF THE DRAWINGS

Generally, like reference numerals in the various figures are utilized to designate like components.

FIG. 1 is a block diagram depicting a computing environment for synchronizing data among computing devices in accordance with an embodiment of the present invention;

FIG. 2A is a block diagram depicting a network of nodes in accordance with an embodiment of the present invention;

FIG. 2B is a block diagram depicting a network of nodes in accordance with an embodiment of the present invention;

FIG. 3 is a process flow diagram depicting a process for electing a leader node in accordance with an embodiment of the present invention;

FIG. 4 is a flow chart depicting a method of electing a leader node in accordance with an embodiment of the present invention;

FIG. 5 is a flow chart depicting a method of synchronizing data between nodes in accordance with an embodiment of the present invention;

FIGS. 6A-6D are block diagrams depicting data synchronization across a network in accordance with an embodiment of the present invention;

FIG. 7 is a flow chart depicting a method of recovering from a network partition event in accordance with an embodiment of the present invention;

FIGS. 8A-8C are block diagrams depicting a network recovering from a partition in accordance with an embodiment of the present invention; and

FIG. 9 is a block diagram depicting a computing device in accordance with an embodiment of the present invention.

### DETAILED DESCRIPTION

Present invention embodiments relate to edge computing, and more specifically, to synchronizing data among computing nodes of an edge computing network. An edge computing device refers to a computing device that enables processing to be performed locally (e.g., at the “edge” of a network), in contrast to forwarding data to a central server for processing. For example, self-driving cars may perform some or all of their processing requirements locally, despite being in contact with a server, in order to reduce latency for important tasks, preserve bandwidth, and the like. Thus, an edge computing network is a network of edge computing devices that are in communication with each other. As edge computing devices may be mobile, an edge computing network may involve or require the wireless exchange of data, and an edge computing network may dynamically change as edge computing devices enter or leave the network.

Due to economic and/or distribution factors, edge computing networks are potentially less reliable and/or are subject to lower transmission rates as compared to other networks. In a network of edge computing devices that are connected by different protocols and/or technologies, it may be difficult for participating devices to maintain a consensus of the most up-to-date version of information being shared across the network. In particular, when edge computing devices cannot reliably communicate with each other, data may not be properly propagated among devices, leading to faults in the network.

Present invention embodiments enable a network of edge computing devices, referred to as nodes, to accurately and reliably achieve data synchronization. In particular, present invention embodiments provide for data synchronization between nodes by ensuring that a leader node is present and properly functioning in order to provide data updates to the other nodes. Thus, present invention embodiments improve the field of computer networking by enabling data, such as statuses of nodes or activities being performed by nodes, to be accurately conveyed to all other participating nodes in an up-to-date, real-time fashion. Accordingly, present invention embodiments have practical applications in contexts in which information is relayed between nodes in a grid system. For example, each vehicle in a fleet of self-driving vehicles can maintain an accurate log of the other vehicles' locations, smart cities can coordinate data between utility monitoring systems, weather monitoring systems, or traffic systems, and the like.

Various other embodiments of the present invention will now be discussed. In some embodiments, the leader node comprises a candidate node prior to being elected as the leader node, the candidate node comprises a former follower node that becomes the candidate node in response to an election timeout elapsing, and the election timeout of each follower node is reset in response to the follower node receiving a heartbeat message from the leader node. Thus, present embodiments provide a mechanism to guarantee that a group of nodes always either has a leader node, or is in the process of electing a leader node, thereby preventing data synchronization from being disrupted. In some embodiments, the candidate node broadcasts a request for votes from the plurality of follower nodes. By broadcasting a request for votes, the candidate node may receive votes from any nodes that are within range, thereby also announcing the candidate node's candidacy as a potential new leader node. In some embodiments, a term number is maintained by each node of the plurality of nodes, and in response to being elected, the leader node increments the term number and transmits instructions to the plurality of follower nodes to cause each follower node to increment the term number maintained by the follower node. Thus, when a failure in communication leads to a network being partitioned, the individual nodes of the network can detect the partition to begin repairing the partition. In some embodiments, in response to a node of the plurality of nodes determining that a new leader node has a higher term number than the node, the node becomes a follower node of the new leader node. By following a node with a higher term count, a follower node can recover from a network partition event. In some embodiments, a subset of nodes of the plurality of nodes no longer receiving data from the leader node causes the subset of nodes to elect, by the subset of nodes, a subset leader node to form a partitioned network comprising the subset of nodes. Thus, during a network partition event, any nodes that are partitioned away from other nodes can form their own sub-network and continue to gather and share data. In some embodiments, in response to the subset of nodes resuming to receive data from the leader node of the plurality of nodes, the subset of nodes become follower nodes of the leader node, and additional data is transmitted from the leader node to the plurality of nodes to cause data logs of each node of the subset of nodes to resynchronize with the data log of the leader node. Thus, when a group of nodes recovers from a network partition event, the data collected or generated by nodes that were unable to communicate during the partition can be synchronized across all nodes. In some embodiments, the leader node receives uncommitted data obtained or produced by the subset of nodes, and wherein the leader node transmits the uncommitted data to the plurality of nodes to cause each node of the plurality of nodes to commit the uncommitted data to the data log maintained by each node of the plurality of nodes. Thus, when a group of nodes that was unable to commit data recovers from a network partition event, the data collected or generated by nodes that were unable to communicate and commit the data during the partition can be committed and synchronized across all nodes.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of embodiments of the invention as set forth hereinafter.

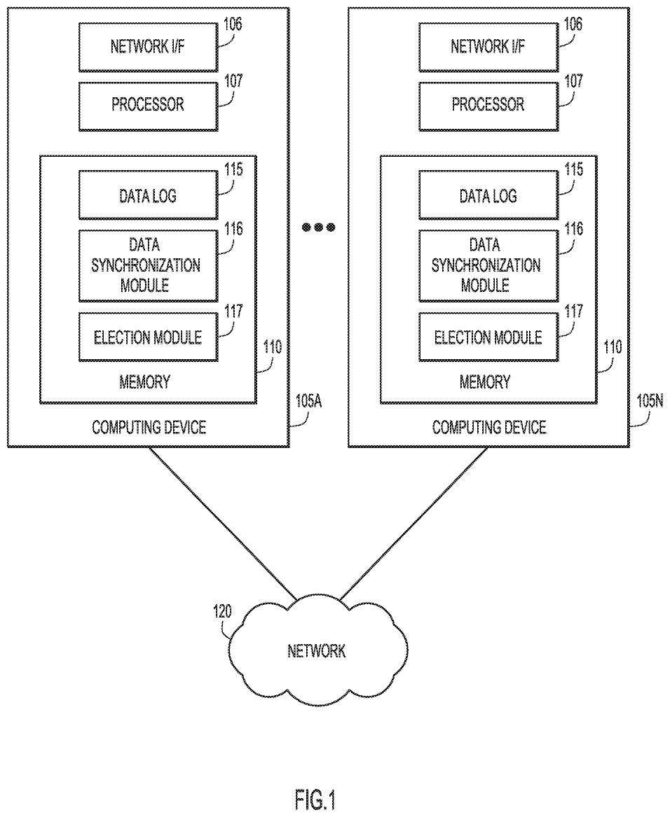

Present invention embodiments will now be described in detail with reference to the Figures. FIG. 1 is a block diagram depicting a computing environment 100 for synchronizing data among computing devices in accordance with an embodiment of the present invention. As depicted, computing environment 100 includes computing devices 105A-105N and a network 120. It is to be understood that the functional division among components of computing environment 100 have been chosen for purposes of explaining present invention embodiments and is not to be construed as a limiting example.

Computing devices 105A-105N each include a network interface (I/F) 106, at least one processor 107, and memory 110 that includes a data log 115, a data synchronization module 116, and an election module 117. Client devices 105A-105N may include any device capable of executing computer readable program instructions. Client devices 105A-105N may include edge computing devices; in various embodiments, client devices 105A-105N may include any combinations of mobile and/or stationary devices, such as smart phones, computing systems for self-driving cars, smart meters, Internet of Things devices, smart home devices, and the like. Network interface 106 enables components of client device 105 to send and receive data over a network, such as network 120. Computing devices 105A-105N may include internal and external hardware components, as depicted and described in further detail with respect to FIG. 9.

Data log 115, data synchronization module 116, and election module 117 may include one or more modules or units to perform various functions of present invention embodiments described below. Data log 115, data synchronization module 116, and election module 117 may be implemented by any combination of any quantity of software and/or hardware modules or units, and may reside within memory 110 of client device 105 for execution by a processor, such as processor 107.

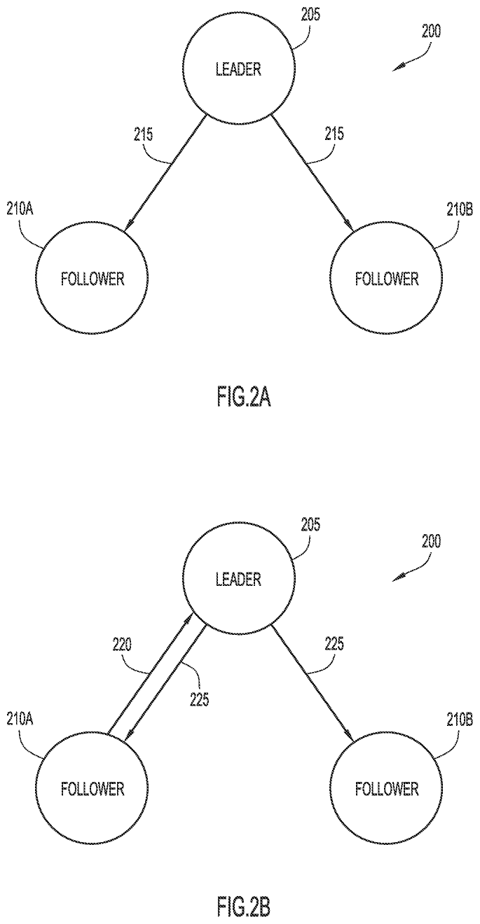

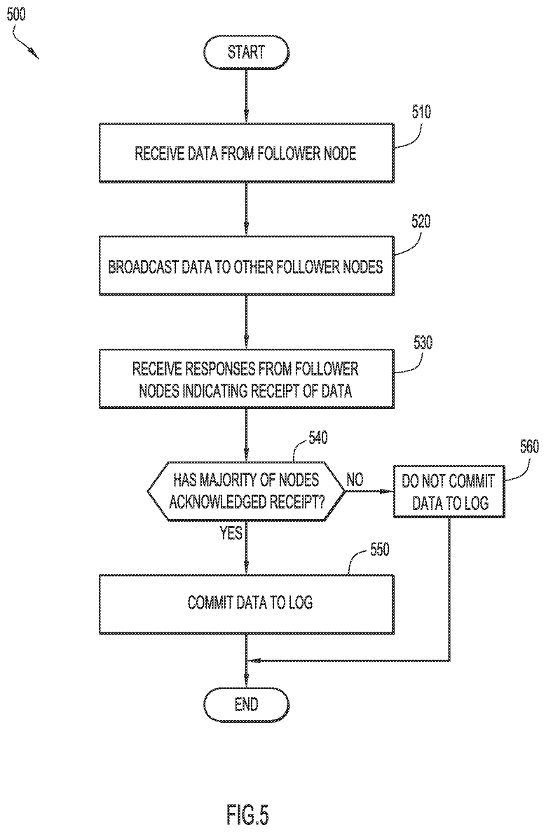

Data log 115 includes data that may be shared between computing devices 105A-105N and other data in accordance with present invention embodiments. Each computing devices 105A-105N may store data in data log 115 based on instructions received from another computing device. In various embodiments, data log 115 includes one or more data entries that identify nodes in an edge computing network, including the status of those nodes (e.g., leader node, follower node, candidate node, etc.), as will be depicted and described in further detail with respect to FIGS. 2A and 2B. Data log 115 may include any data that each computing device 105A-105N has been instructed to commit to data log 115, and as such can include any desired data. Data logs 115 of computing devices 105A-105N may be synchronized in accordance with present invention embodiments, as depicted and described in further detail with respect to FIG. 5.

Data synchronization module 116 enables computing devices 105A-105N to synchronize data in accordance with present invention embodiments. In general, data synchronization module 116 enables each computing device 105A-105N to provide data, either obtained or generated by that computing device, to a computing device functioning as a leader node. Data synchronization module 116 may also process and/or store data received by a computing device functioning as a leader node, such as committing the data to data log 115. In some embodiments, data synchronization module 116 enables any computing devices 105A-105N that are functioning as a leader node to receive and transmit data to achieve data synchronization in accordance with present invention embodiments.

Election module 117 enables computing devices 105A-105N to participate in elections and/or operate as candidate or leader nodes in accordance with present invention embodiments. In some embodiments, election module 117 listens for, and/or responds to, heartbeat messages from a leader node. In some embodiments, election module 117 causes any of computing devices 105A-105N to enter into a candidate status in response to no longer receiving a heartbeat message, in which case election module 117 may transmit a request for votes and cause a computing device to become a leader node when enough votes are received.

Network 120 may include a local area network (LAN), a wide area network (WAN) such as the Internet, or a combination of the two, and includes wired, wireless, or fiber optic connections. In general, network 120 can be any combination of connections and protocols known in the art that will support communications between computing devices 105A-105N via their respective network interfaces in accordance with embodiments of the present invention. In particular, network 120 may be an edge computing network, and members of network 120 (e.g., computing devices 105A-105N) may join and leave when the members come within wireless communication range of other members. In various embodiments, network 120 may be implemented using one or more communication protocols or technologies, such as a low-power wide-area network (LPWAN) technology, a Li-Fi technology, a Near-Field Communication (NFC) protocol, a Long Term Evolution (LTE) Advanced communication standard, a Narrowband Internet of Things (NB-IoT) standard, and the like.

FIG. 2A is a block diagram depicting a network 200 of nodes in accordance with an embodiment of the present invention. As depicted, network 200 includes three nodes: a leader node 205, and two follower nodes 210A and 210B. The nodes of network 200 may each correspond to any of computing devices 105A-105N of computing environment 100 depicted in FIG. 1, and accordingly may be implemented by computer 10 that is depicted and described in further detail with respect to FIG. 9.

In some embodiments, nodes may be in one of three states: a leader state, a candidate state, and a follower state, with follower nodes receiving instructions from a leader node, and candidate nodes only existing during an interim in which a leader node is not currently designated. As shown in network 200, leader node 205 may regularly broadcast data 215 that can be received by follower nodes 210A and 210B. Data 215 can include a heartbeat message advertising that leader node 205 is currently operating as a leader node and/or other data, such as data to synchronize across all of the nodes of network 200. In some embodiments, any data 215 sent by leader node 205 may indicate leader node 205 as the source of the data, and may therefore serve as a heartbeat message.

FIG. 2B is a block diagram depicting a network 200 of nodes in accordance with an embodiment of the present invention. As depicted, network 200 includes three nodes: a leader node 205, and two follower nodes 210A and 210B. Network 200 of FIG. 2B corresponds to network 200 of FIG. 2A at a later point in time.

In order for data to be synchronized across nodes, a node that is the source of the data may share the data with a leader node. As shown in network 201, follower node 210A sends data 220 to leader node 205. Subsequently, leader node 205 may transmit a broadcast 225 including the data 220 that was received from follower node 210A so that other nodes (e.g., follower node 210B) may commit the data to their data logs, an operation that is permitted by virtue of receiving the data from a leader node. Thus, for example, if follower node 210A had broadcast (rather than unicast) data 220 (as may be the case for wireless communication technologies), and follower 210B receives data 220, follower node 210B would not commit the data to its data log, as the source (follower node 210A) is not a leader node.

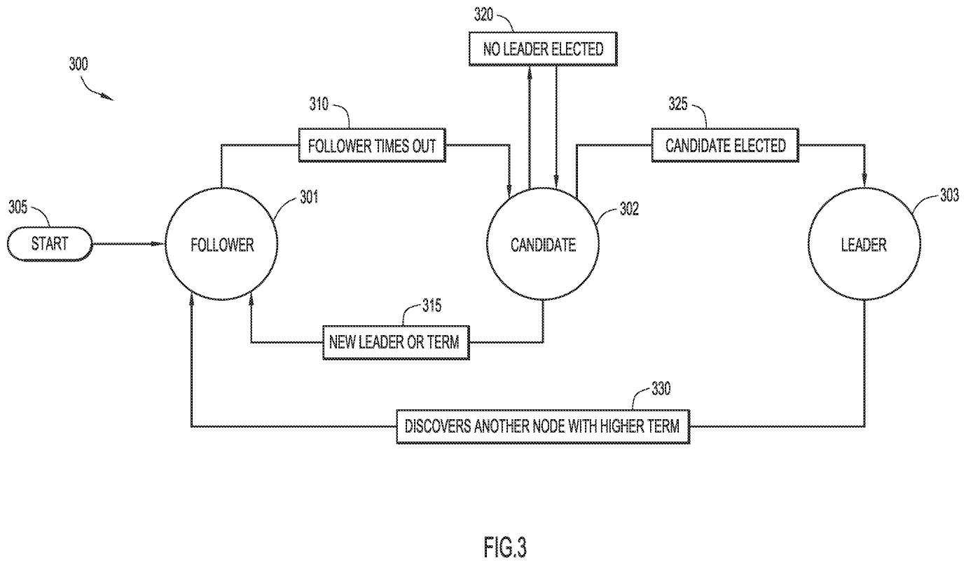

FIG. 3 is a process flow diagram depicting a process 300 for electing a leader node in accordance with an embodiment of the present invention. As shown in process 300, a same node can enter either a follower state 301, a candidate state 302, or a leader state 303, depending on particular conditions being satisfied.

At operation 305, a node is started. The node may be started via a state machine replication approach to provide fault tolerance. Initially, a node enters a follower state 301 and waits to receive data from a leader node. When a node is in a follower state, the node starts counting down a specified period of time, referred to as an election timeout.

At operation 310, the follower node's election timeout elapses, and the follower node changes status to enter a candidate state 302. A candidate node is no longer a follower node, but is rather a potential candidate to be elected by other nodes as a leader node. Each election cycle may be associated with an election term number, which can be represented as an integer that is incremented after a leader is elected.

A candidate node may be elected as a leader node when the candidate node receives votes from a majority of the nodes of a network. However, a candidate node may not necessarily be elected as a leader node. At operation 315, the candidate node reverts back to follower state 301 because either another candidate node has been elected as leader, or because another election term starts. Another election term may start if no leader is elected within a predetermined duration of time at operation 320. In particular, if a node in candidate state 302 does not receive a majority of votes from other nodes within the predetermined threshold of time, then no leader is elected (operation 320), and the node reverts back to a follower node (operation 315). A candidate node may not receive a majority of votes because communication with other nodes is disrupted and/or because one or more rival candidate nodes have received enough votes to prevent the candidate node from receiving a majority of votes.

If a candidate node receives votes from a majority of the other nodes in a network, the candidate node is elected as a leader node at operation 325, and undergoes another status change to leader status 303. A leader node may remain in leader state 303, issuing heartbeat messages and updating data logs of follower nodes, until the leader node encounters data indicating that another node has a higher election term number than the leader node, thus indicating that another leader node exists and that the subject leader node may be out of synchronization. When a leader node discovers another node with a higher election term number at operation 330, the leader node demotes itself to follower status 301 and begins following the leader node associated with the higher election term number.

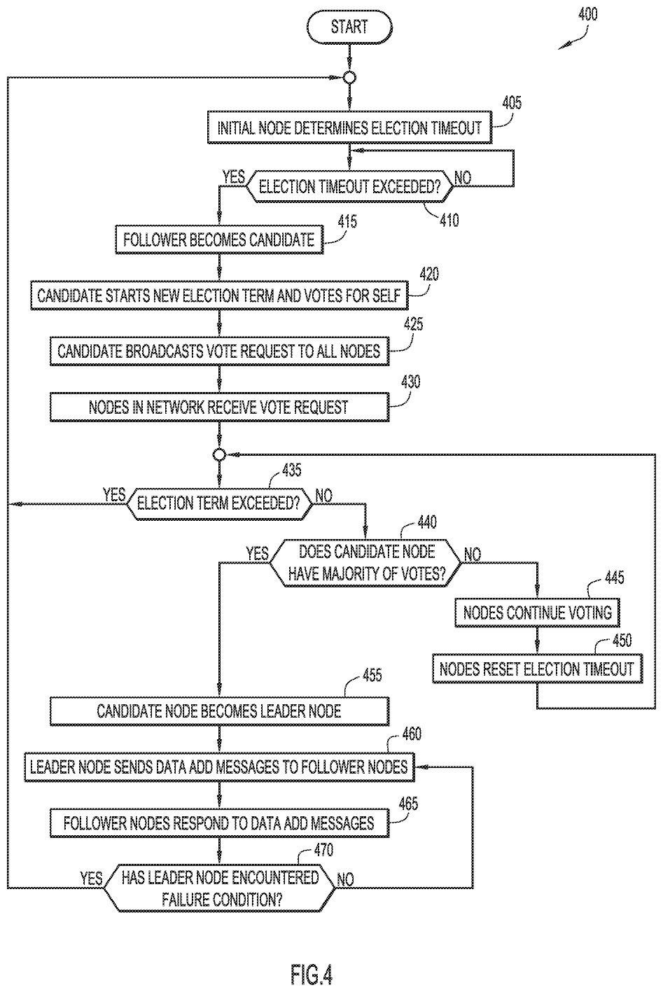

FIG. 4 is a flow chart depicting a method 400 of electing a leader node in accordance with an embodiment of the present invention.

At operation 405, a node starts and determines an election timeout duration. Initially, the node is in a follower state. The election timeout duration may be a randomly-selected number between a minimum and maximum value, such as a span of time between two hundred milliseconds and five hundred milliseconds. Additionally or alternatively, the election timeout duration may be selected based on underlying network performance indicators. For example, if a network is experiencing high latency, a longer duration of time may be used for the election timeout.

Operation 410 determines whether the election timeout for the follower node has been exceeded. If not, the follower node continues waiting to receive data from a leader node. If the election timeout is exceeded, then the follower node changes status and becomes a candidate node at operation 415.

The candidate node starts a new election term and votes for itself at operation 420. Additionally, the candidate note increments the election term number. The candidate node also broadcasts a vote request to all nodes at operation 425. Any nodes within range may receive the request, which may include an identity of the candidate node (e.g., using a unique identifier, Internet Protocol (IP) address, media access control (MAC) address, etc.) as a candidate node. The request to vote may also include the updated election term number.

The other nodes in the network receive the vote request at operation 430. When another follower node receives a request to vote, the follower node replies with a message indicating that it is voting for the candidate node, unless the follower node has already cast a vote. In some embodiments, follower nodes are prevented from voting twice in an election term based on the election term number included in the request to vote: a follower node may only cast one vote per election term. Thus, in the event that there are rival candidate nodes in a same election term, a follower node may vote for whichever candidate node's request to vote is first received by the follower node.

Operation 435 determines whether the election term's duration has been exceeded. The election term may be a predefined length of time, such as a span of time in the range of milliseconds or seconds. In the event that multiple competing candidate nodes prevent each other from obtaining votes from a majority of the nodes, the election term's expiration will lead to another election term, thus ensuring that a leader node can be elected. Accordingly, if the candidate node determines that the election term's duration has been exceeded at operation 435, the candidate node reverts to a follower node, determines another election timeout duration at operation 405, and waits for the election timeout to be exceeded at operation 410.

If the election term duration has not yet been exceeded, the candidate node determines at operation 440 whether the candidate node has received votes from a majority of the nodes in the network. The number of nodes in a network may be determined based on data that was previously received by the candidate node as a follower node and from a leader node. In some embodiments, a leader node may determine a count of all nodes in a network based on the number of nodes that have replied to a heartbeat message of the leader node.

If the candidate node determines at operation 440 that the candidate node has not received a majority of votes, then the candidate node continues waiting for additional votes as long as the election term is not exceeded, and the other nodes continue voting at operation 445. When a follower node responds to a request to vote, the candidate node's election term duration is reset at operation 450.

If a candidate node determines that it has received a majority of the votes at operation 440, then the candidate node changes status and becomes a leader node at operation 455. As a leader node, the node begins to broadcast data add messages to follower nodes at operation 460. Data add messages may include instructions to add data to the data logs of follower nodes. Additionally or alternatively, the leader node may broadcast heartbeat messages. In some embodiments, data add messages may function as heartbeat messages.

The follower nodes respond to the data add messages and/or heartbeat messages at operation 465. By responding to the messages, the follower nodes indicate to the leader node that the leader node's data is being received, thus verifying that data synchronization is being achieved.

At operation 470, the leader node determines whether it has encountered a failure condition. In some embodiments, a failure condition may be met if a predetermined number of follower nodes, such as one node, multiple nodes, or all nodes, stop responding to the leader node's messages. In some embodiments, a failure condition may include a particular error or status of the leader node, such as a software error, hardware error, and the like. If the leader node encounters a failure condition, the leader node may step down and become a follower node, thus returning to operation 405 to determine an election timeout and wait to potentially become a candidate node again. As long as the leader node has not encountered a failure condition, the leader node continues functioning as leader node until the election term is exceeded.

FIG. 5 is a flow chart depicting a method 500 of synchronizing data between nodes in accordance with an embodiment of the present invention.

A leader node receives data from a follower node at operation 510. When a follower node obtains or produces data that should be synchronized across nodes in a network, the follower node may transmit the data in a data synchronization request to the leader node. For example, a follower node may obtain data including a position of the follower node, which should be shared with other nodes so that the network of nodes can track their positions with respect to each other.

The leader node broadcasts the data to other follower nodes at operation 520. When a leader node receives data in a data synchronization request, the leader node may not initially commit the data to the leader node's own data log. Rather, the leader node may broadcast the data by including the data in a data add message, so that all of the other follower nodes capable of receiving the broadcast can commit the data to their own data logs. When a follower node receives the data add message, the follower node may temporarily store the data in memory without committing the data to a data log, and the follower node may respond to the leader node to acknowledge that the data add message was received.

The leader node receives responses from the follower nodes indicating their receipt of the broadcasted data at operation 530. At operation 540, the leader node determines whether a majority of the follower nodes have responded to acknowledge receipt of the data. If a majority of the follower nodes fail to acknowledge receipt of the data, then the data is not committed to the data log of the leader node at operation 560. Likewise, the data may be purged from the memory of follower nodes rather than committed to their data logs.

If a leader node receives messages from a majority of follower nodes acknowledging receipt of the data, then the leader node commits the data to a data log at operation 550. A leader node may indicate that the data has been committed in one or more messages, such as heartbeat messages, data add messages, or any other broadcast, to follower nodes, causing the follower nodes to likewise commit the data to their individual data logs. Thus, data that is originally obtained or produced by a single follower node may be replicated and synchronized across a network of nodes.

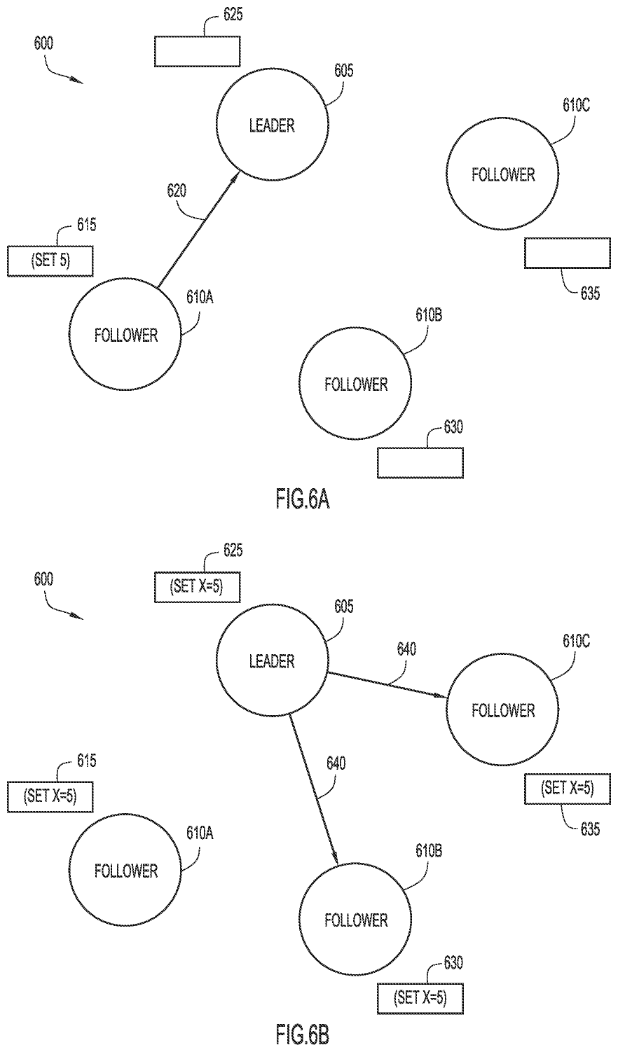

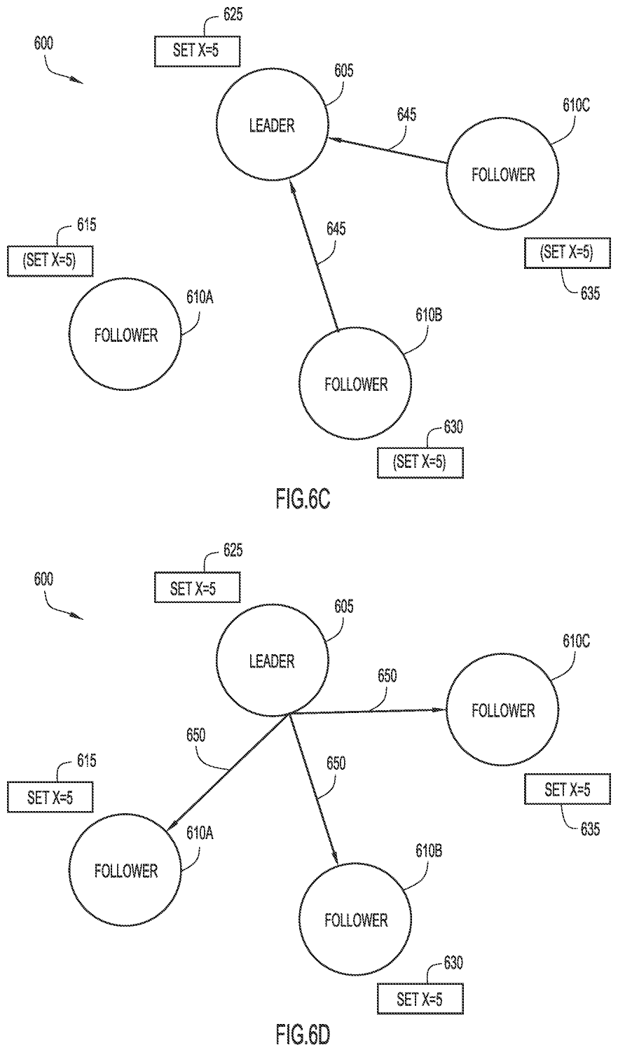

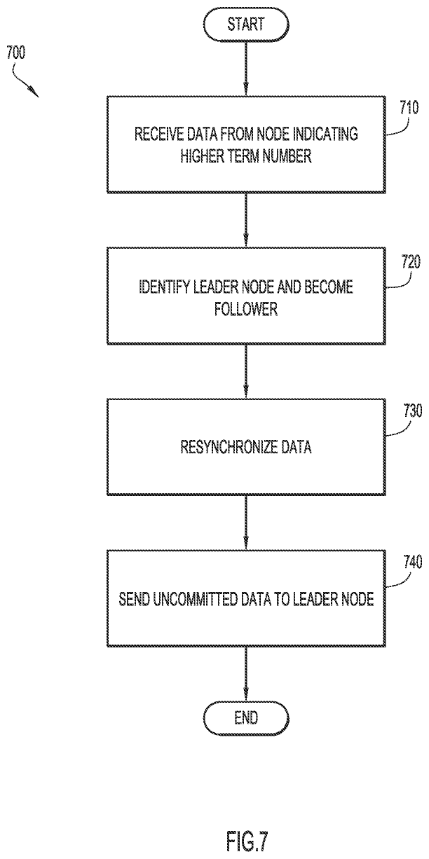

FIGS. 6A-6D are block diagrams depicting data synchronization across a network 600 in accordance with an embodiment of the present invention. The network 600 depicted in each of FIGS. 6A-6D may correspond to a same network of nodes at different points in time.

As shown in FIG. 6A, network 600 includes a leader node 605 and three follower nodes 610A, 610B, and 610C. Initially, follower node 610A includes in its memory 615 data (e.g., “SET 5”) that is being sent via a data synchronization request 620 to leader node 605. As the data has not been synchronized across the nodes of network 600, follower 610A may temporarily hold the data in memory rather than commit to its data log, as indicated by the parentheses.

As shown in FIG. 6B, leader node 605 temporarily holds the data in memory 625 (as indicated by the parentheses) and broadcasts, via an add data message 640, the data, which is received by follower nodes 610B and 610C. Upon receiving the data, follower nodes 610B and 610C also temporarily hold the data in their respective memory 630 and 635.

Next, FIG. 6C depicts followers 610B and 610C each transmitting a response 645 acknowledging receipt of the data. In response to leader 605 receiving a response acknowledging receipt of the data, leader 605 commits the data to its data log (as indicated by a lack of parentheses).

As depicted in FIG. 6D, after leader 605 commits the data to a data log, leader 605 broadcasts instructions 650 for the follower nodes 610A, 610B, and 610C to commit the data to their data logs. Thus, the data (“SET X=5”) is successfully synchronized across all nodes of network 600.

FIG. 7 is a flow chart depicting a method 700 of recovering from a network partition event in accordance with an embodiment of the present invention. A network partition event may refer to any disruption in communication between nodes that causes the nodes to break down into smaller networks. Communication between nodes can be disrupted due to interfering wireless signals, the distance between nodes becoming too great, or any other factor that would prevent nodes in a network from remaining in communication with each other. When a network partition event causes follower nodes to no longer exchange data with a leader node, those follower nodes may elect a new leader among themselves in accordance with present invention embodiments, resulting in a partitioned network of multiple leader nodes. Moreover, election of multiple leader nodes causes partitioned groups of nodes to have different election term numbers, which may be used to identify a network partition event.

Data is received by a node from another node indicating a higher election term number at operation 710. Data exchanged in a network of nodes may include a tag indicating the current election term number of the network, as defined by the leader of the nodes. Thus, when a node receives data from another node that has a higher election term number, the node may determine that it has lost synchronization with other nodes.

The leader node associated with the higher election term is identified, and node having the lower election term number becomes a follower of that leader node at operation 720. If the data received at operation 710 is identified as data from a leader node, then the receiving node may simply become a follower of that leader node. If the data received at operation 710 corresponds to a message broadcast by a follower node, then the receiving node may listen for a heartbeat from the leader node having the higher election term number in order to identify the leader node. In some embodiments, a node may broadcast a request to one or more other nodes requesting identification of a leader node.

Data is resynchronized between the nodes at operation 730. When a node becomes a follower of a leader node having a higher election term number, the follower node may begin to receive data add messages from the leader node, which can include a full copy of the leader node's data log. Thus, the follower node may resynchronize with a leader node and the network may be restored to a state prior to the network partition event.

At operation 740, the follower node may send uncommitted data to its new leader node. During the network partition event, separated nodes may obtain or generate additional data that remains uncommitted, as the data cannot be shared with enough nodes, due to the data partition event, to achieve consensus among a majority of nodes. Thus, any uncommitted data may be sent to the leader via a data synchronization request in order to ensure that additional data generated or obtained during the network partition event is also synchronized across nodes of a network.

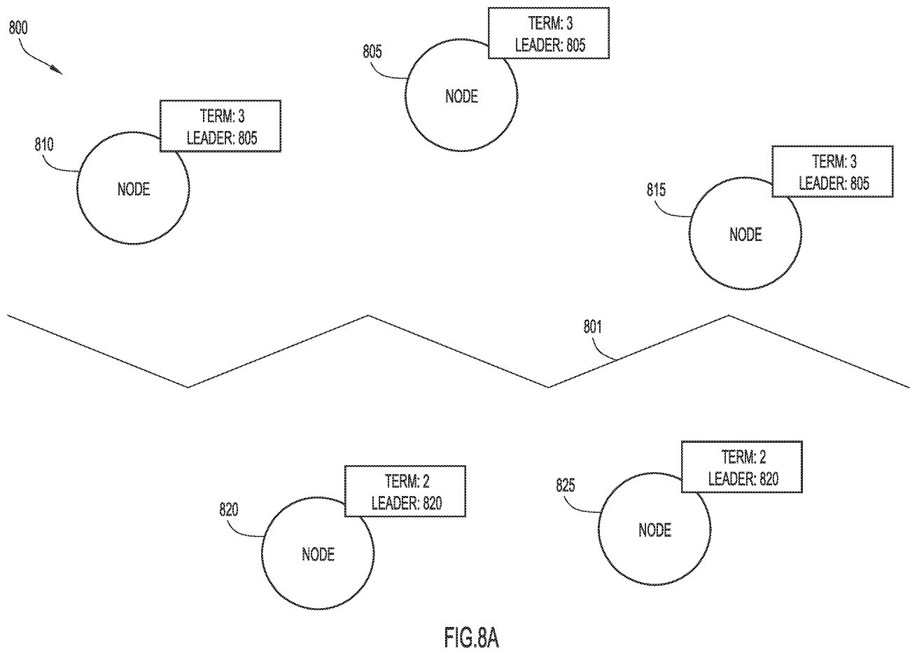

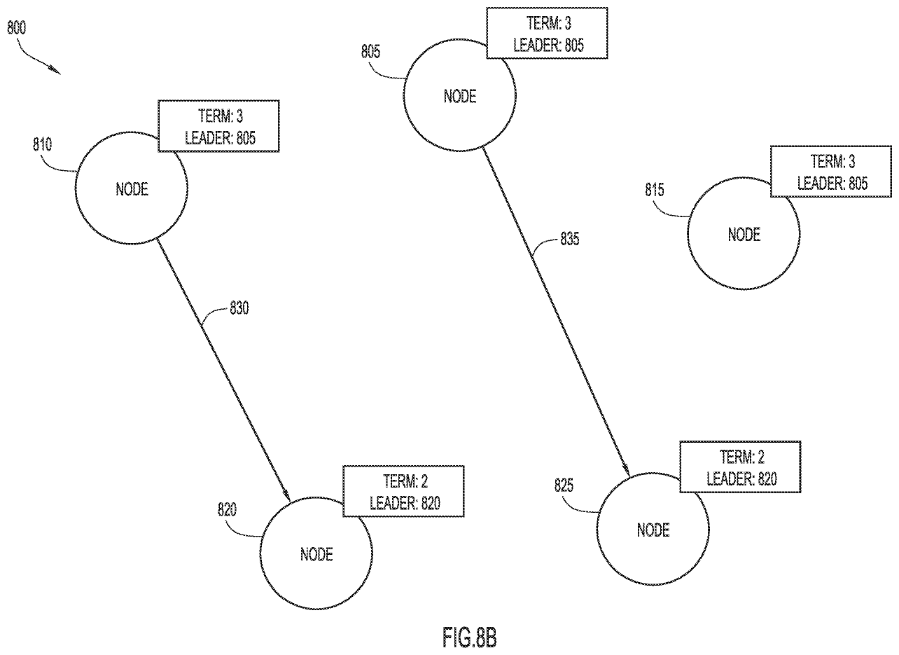

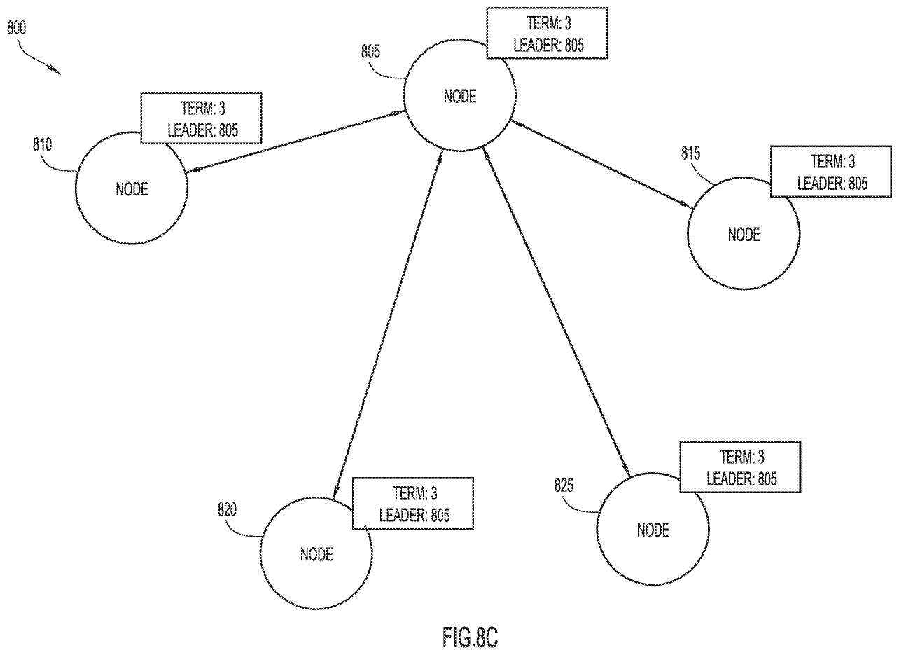

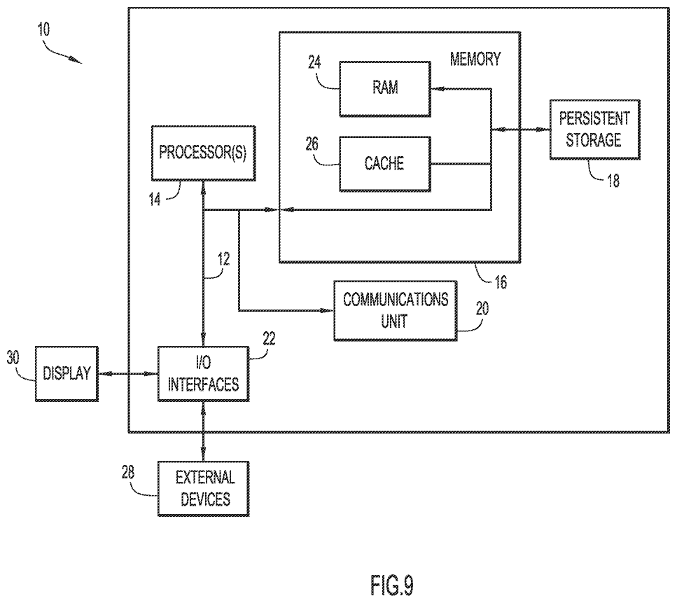

FIGS. 8A-8C are block diagrams depicting a network 800 recovering from a partition in accordance with an embodiment of the present invention. The network 800 depicted in each of FIGS. 8A-8C may correspond to a same network of nodes at different points in time.

As depicted in FIG. 8A, a partition 801 has formed between nodes in a network, preventing nodes 805, 810, and 815 from communicating with nodes 820 and 825. Partition 801 is not necessarily a physical partition, but can include any event or circumstances that prevent nodes from remaining in communication with each other.

Prior to the partition, node 820 served as a leader node for all of the nodes in network 800. Due to the partition, nodes 805, 810, and 815 may be unable to communicate with nodes 820 and/or 825, causing another election to occur among nodes 805, 810, and 815, which raises the election term number of nodes 805, 810, and 815 relative to nodes 820 and 825. In particular, nodes 805, 810, and 815 have elected node 805 as leader, and the election term number has been raised to 3.

Since the total number of nodes in network 800 is five, a majority of nodes requires at least three nodes to acknowledge receipt of data in order for data to be committed. Thus, data produced or obtained by any of nodes 805, 810, and/or 815 can be synchronized across those nodes. However, leader node 820 will be unable to commit data generated or obtained by node 820 or 825, as the most number of nodes that can acknowledge receipt of data in the network in which node 820 is a leader is two nodes.

In FIG. 8B, the network partition event has ended, and nodes may rediscover each other. In the depicted example, node 820 may receive data from node 810, indicating that nodes with a higher election term number exist. Similarly, node 825 may receive data from node 805 indicating that a higher election term number exists. In response, nodes 820 and 825 may become followers of leader node 805, as shown in FIG. 8C. Thus, nodes 820 and 825 may receive data to resynchronize with the data log of node 805, and/or may transmit data synchronization request to have any uncommitted data of nodes 820 and/or 825 committed across network 800 by leader node 805.

FIG. 9 is a block diagram depicting components of a computer 10 suitable for executing the methods disclosed herein. Computer 10 may implement any computing devices described herein, such as edge computing devices 105A-105N, in accordance with embodiments of the present invention. It should be appreciated that FIG. 9 provides only an illustration of one embodiment and does not imply any limitations with regard to the environments in which different embodiments may be implemented. Many modifications to the depicted environment may be made.

As depicted, the computer 10 includes communications fabric 12, which provides communications between computer processor(s) 14, memory 16, persistent storage 18, communications unit 20, and input/output (I/O) interface(s) 22. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Memory 16 and persistent storage 18 are computer readable storage media. In the depicted embodiment, memory 16 includes random access memory (RAM) 24 and cache memory 26. In general, memory 16 can include any suitable volatile or non-volatile computer readable storage media.

One or more programs may be stored in persistent storage 18 for execution by one or more of the respective computer processors 14 via one or more memories of memory 16. The persistent storage 18 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Communications unit 20, in these examples, provides for communications with other data processing systems or devices. In these examples, communications unit 20 includes one or more network interface cards. Communications unit 20 may provide communications through the use of either or both physical and wireless communications links.

I/O interface(s) 22 allows for input and output of data with other devices that may be connected to computer 10. For example, I/O interface 22 may provide a connection to external devices 28 such as a keyboard, keypad, a touch screen, and/or some other suitable input device. External devices 28 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 18 via I/O interface(s) 22. I/O interface(s) 22 may also connect to a display 30. Display 30 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Data relating to data synchronization in edge computing networks (e.g., data generated or obtained by nodes, election term data, node count data, heartbeat message data, data committed to data logs, etc.) may be stored within any conventional or other data structures (e.g., files, arrays, lists, stacks, queues, records, etc.) and may be stored in any desired storage unit (e.g., database, data or other repositories, queue, etc.). The data transmitted between computing devices 105A-105N (e.g., data transmitted between any leader nodes, follower nodes, and/or candidate nodes) may include any desired format and arrangement, and may include any quantity of any types of fields of any size to store the data. The definition and data model for any datasets may indicate the overall structure in any desired fashion (e.g., computer-related languages, graphical representation, listing, etc.).

Data relating to data synchronization in edge computing networks (e.g., data generated or obtained by nodes, election term data, node count data, heartbeat message data, data committed to data logs, etc.) may include any information provided to, or generated by, computing devices 105A-105N (e.g., data transmitted between any leader nodes, follower nodes, and/or candidate nodes). Data relating to data synchronization in edge computing networks may include any desired format and arrangement, and may include any quantity of any types of fields of any size to store any desired data. The data relating to data synchronization in edge computing networks may include any data collected about entities by any collection mechanism, any combination of collected information, and any information derived from analyzing collected information.

The present invention embodiments may employ any number of any type of user interface (e.g., Graphical User Interface (GUI), command-line, prompt, etc.) for obtaining or providing information (e.g., data relating to data synchronization in edge computing networks), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

It will be appreciated that the embodiments described above and illustrated in the drawings represent only a few of the many ways of improving communication synchronization of data between network devices.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., communications software, server software, data synchronization module 116, election module 117, etc.). These systems may include any types of monitors and input devices (e.g., keyboard, mouse, voice recognition, etc.) to enter and/or view information.

It is to be understood that the software (e.g., communications software, server software, data synchronization module 116, election module 117, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., communications software, server software, data synchronization module 116, election module 117, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to data synchronization in edge computing networks). The database system may be implemented by any number of any conventional or other databases, data stores or storage structures (e.g., files, databases, data structures, data or other repositories, etc.) to store information (e.g., data relating to data synchronization in edge computing networks). The database system may be included within or coupled to the server and/or client systems. The database systems and/or storage structures may be remote from or local to the computer or other processing systems, and may store any desired data (e.g., data relating to data synchronization in edge computing networks).

The present invention embodiments may employ any number of any type of user interface (e.g., Graphical User Interface (GUI), command-line, prompt, etc.) for obtaining or providing information (e.g., data relating to data synchronization in edge computing networks), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for any number of applications in the relevant fields, including, but not limited to, data synchronization in edge computing networks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for synchronizing data in an edge computing network comprising:
receiving, at a leader node of a plurality of nodes including a plurality of follower nodes, a request from a follower node comprising data to be replicated across the plurality of nodes, wherein the leader node is elected as the leader node in response to receiving votes from a majority of the plurality of nodes, wherein a node of the plurality of nodes casts at most a single vote, and wherein each node comprises a wirelessly-communicating computing device;
transmitting the data from the leader node to the plurality of nodes; and
in response to the leader node receiving responses acknowledging receipt of the data from the majority of the plurality of nodes, transmitting, by the leader node, instructions to the plurality of nodes to cause each node to commit the data to a data log maintained by each node.

2. The computer-implemented method of claim 1, wherein the leader node comprises a candidate node prior to being elected as the leader node, and wherein the candidate node comprises a former follower node that becomes the candidate node in response to an election timeout elapsing, and wherein the election timeout of each follower node is reset in response to the follower node receiving a heartbeat message from the leader node.

3. The computer-implemented method of claim 2, wherein the candidate node broadcasts a request for votes from the plurality of follower nodes.

4. The computer-implemented method of claim 1, wherein a term number is maintained by each node of the plurality of nodes, and wherein in response to being elected, the leader node increments the term number and transmits instructions to the plurality of follower nodes to cause each follower node to increment the term number maintained by the follower node.

5. The computer-implemented method of claim 4, wherein in response to a node of the plurality of nodes determining that a new leader node has a higher term number than the node, the node becomes a follower node of the new leader node.

6. The computer-implemented method of claim 1, wherein a subset of nodes of the plurality of nodes no longer receiving data from the leader node causes the subset of nodes to:
elect, by the subset of nodes, a subset leader node to form a partitioned network comprising the subset of nodes.

7. The computer-implemented method of claim 6, wherein in response to the subset of nodes resuming to receive data from the leader node of the plurality of nodes, the subset of nodes become follower nodes of the leader node, and further comprising:
transmitting additional data from the leader node to the plurality of nodes to cause data logs of each node of the subset of nodes to resynchronize with the data log of the leader node.

8. The computer-implemented method of claim 7, wherein the leader node receives uncommitted data obtained or produced by the subset of nodes, and wherein the leader node transmits the uncommitted data to the plurality of nodes to cause each node of the plurality of nodes to commit the uncommitted data to the data log maintained by each node of the plurality of nodes.

9. A computer system for synchronizing data in an edge computing network, the computer system comprising:
one or more computer processors;
one or more computer readable storage media;
program instructions stored on the one or more computer readable storage media for execution by at least one of the one or more computer processors, the program instructions comprising instructions to:
receive, at a leader node of a plurality of nodes including a plurality of follower nodes, a request from a follower node comprising data to be replicated across the plurality of nodes, wherein the leader node is elected as the leader node in response to receiving votes from a majority of the plurality of nodes, wherein a node of the plurality of nodes casts at most a single vote, and wherein each node comprises a wirelessly-communicating computing device;
transmit the data from the leader node to the plurality of nodes; and
in response to the leader node receiving responses acknowledging receipt of the data from the majority of the plurality of nodes, transmit, by the leader node, instructions to the plurality of nodes to cause each node to commit the data to a data log maintained by each node.

10. The computer system of claim 9, wherein the leader node comprises a candidate node prior to being elected as the leader node, and wherein the candidate node comprises a former follower node that becomes the candidate node in response to an election timeout elapsing, and wherein the election timeout of each follower node is reset in response to the follower node receiving a heartbeat message from the leader node.

11. The computer system of claim 10, wherein the candidate node broadcasts a request for votes from the plurality of follower nodes.

12. The computer system of claim 9, wherein a term number is maintained by each node of the plurality of nodes, and wherein in response to being elected, the leader node increments the term number and transmits instructions to the plurality of follower nodes to cause each follower node to increment the term number maintained by the follower node.

13. The computer system of claim 12, wherein in response to a node of the plurality of nodes determining that a new leader node has a higher term number than the node, the node becomes a follower node of the new leader node.

14. The computer system of claim 9, wherein a subset of nodes of the plurality of nodes no longer receiving data from the leader node causes the subset of nodes to:
elect, by the subset of nodes, a subset leader node to form a partitioned network comprising the subset of nodes.

15. The computer system of claim 14, wherein in response to the subset of nodes resuming to receive data from the leader node of the plurality of nodes, the subset of nodes become follower nodes of the leader node, and further comprising instructions to:
transmit additional data from the leader node to the plurality of nodes to cause data logs of each node of the subset of nodes to resynchronize with the data log of the leader node.

16. The computer system of claim 15, wherein the leader node receives uncommitted data obtained or produced by the subset of nodes, and wherein the leader node transmits the uncommitted data to the plurality of nodes to cause each node of the plurality of nodes to commit the uncommitted data to the data log maintained by each node of the plurality of nodes.

17. A computer program product for synchronizing data in an edge computing network, the computer program product comprising one or more computer readable storage media collectively having program instructions embodied therewith, the program instructions executable by a computer to cause the computer to:
receive, at a leader node of a plurality of nodes including a plurality of follower nodes, a request from a follower node comprising data to be replicated across the plurality of nodes, wherein the leader node is elected as the leader node in response to receiving votes from a majority of the plurality of nodes, wherein a node of the plurality of nodes casts at most a single vote, and wherein each node comprises a wirelessly-communicating computing device;
transmit the data from the leader node to the plurality of nodes; and
in response to the leader node receiving responses acknowledging receipt of the data from the majority of the plurality of nodes, transmit, by the leader node, instructions to the plurality of nodes to cause each node to commit the data to a data log maintained by each node.

18. The computer program product of claim 17, wherein the leader node comprises a candidate node prior to being elected as the leader node, and wherein the candidate node comprises a former follower node that becomes the candidate node in response to an election timeout elapsing, and wherein the election timeout of each follower node is reset in response to the follower node receiving a heartbeat message from the leader node.

19. The computer program product of claim 18, wherein the candidate node broadcasts a request for votes from the plurality of follower nodes.

20. The computer program product of claim 17, wherein a term number is maintained by each node of the plurality of nodes, and wherein in response to being elected, the leader node increments the term number and transmits instructions to the plurality of follower nodes to cause each follower node to increment the term number maintained by the follower node.

21. The computer program product of claim 20, wherein in response to a node of the plurality of nodes determining that a new leader node has a higher term number than the node, the node becomes a follower node of the new leader node.

22. The computer program product of claim 17, wherein a subset of nodes of the plurality of nodes no longer receiving data from the leader node causes the subset of nodes to:
elect, by the subset of nodes, a subset leader node to form a partitioned network comprising the subset of nodes.

23. The computer program product of claim 22, wherein in response to the subset of nodes resuming to receive data from the leader node of the plurality of nodes, the subset of nodes become follower nodes of the leader node, and wherein the program instructions further cause the computer to:
transmit additional data from the leader node to the plurality of nodes to cause data logs of each node of the subset of nodes to resynchronize with the data log of the leader node.

24. The computer program product of claim 23, wherein the leader node receives uncommitted data obtained or produced by the subset of nodes, and wherein the leader node transmits the uncommitted data to the plurality of nodes to cause each node of the plurality of nodes to commit the uncommitted data to the data log maintained by each node of the plurality of nodes.
